(19) United States
(12) Patent Application Publication
(10) Pub. No.: US 2002/0059457 A1
(43) Pub. Date: May 16, 2002

(54) System and method for the remote creation of notification agents for wireless devices

(76) Inventors: Glenn Wesley Ballard, Morrisville, PA (US); Richard Wendell Martin JR., Allen, TX (US)

Correspondence Address: Woodbridge & Associates, P.C., P.O. Box 592, Princeton, NJ, 08542, US

(21) Appl. No.: 09/899,648

(22) Filed: Jul. 6, 2001

Related U.S. Application Data
(60) Provisional application No. 60/216,088, filed on Jul. 6, 2000.

(51) Int. Cl. G06F 15/16

(52) U.S. Cl. 709/246

(57) ABSTRACT

A Real-Time Data Agent (RTDA) is capable of providing very thin wireless network clients (those having limited operating system and bandwidth capability) with the ability to create, initiate, and remotely control server agents to give immediate notification for relevant changes (defined by boolean-based criteria) for any World Wide Web (or Intranet) data that can be viewed on the given device. Quite simply, it provides an expedient function for a user to receive notification of relevant information from any World Wide Web page or data that can be viewed on a thin (wireless) device or client. RTDA focuses on data telephones and clipping browsers, especially those using WAP (wireless application protocol). Though the invention runs primarily from an application server within the Internet (or central network), its main feature is found in a screen interface for the client device (e.g. data-capable cellular phone). This key technology comprising an actionable interface that allows a user to instantly convert any page as an actionable vertical list, from which any element can be selected for notification per a defined set of boolean-based criteria. It is called “real-time” because the agent server returns a link to the original page address when the criteria are met, thereby delivering the most current version of the data.

### CROSS REFERENCE TO RELATED APPLICATIONS

This Application claims the benefit of U.S. Provisional Patent Application Serial No. 60/216,088 filed on Jul. 6, 2000 entitled “Real-Time Data Agent” by Glenn Wesley Ballard and Richard Wendell Martin Jr., the entire contents and substance of which are hereby incorporated by reference.

### BACKGROUND OF THE INVENTION

1. Field of the Invention

The invention, a real-time data agent (RTDA), relates to a computer system and method that provides data-capable cellular phones and other small wireless devices with an expedient mechanism for real-time notification of dynamic information content on any World Wide Web (Internet) page that can be viewed from the wireless device.

2. Description of Related Art

The Internet is not one single network as commonly believed, but a network of interconnected networks, some of which are wireless. Mobile wireless networks are quite distinct and somewhat separate from the “wired” (physically connected high-bandwidth) portion of the network, although wireless networks may have links to the rest of the Internet to receive messages and view content. Despite increasingly common standards across the whole system of networks (TCP/IP, HTTP, browser client interface), underlying differences between wired and wireless communications tend to outweigh superficial similarities.

From its beginning, mobile wireless computing has grown separately from fixed site networking. The rise of the world wide web brought an intersection of key technologies (e.g., TCP/IP packet networking and the browser application paradigm), but the popular notion of absolute convergence between wired and wireless technologies has thus far been a fallacy. Even as visible commonalities have appeared between networks, so also has the gulf between wired and wireless grown. The most obvious differentiation being in the resources available, especially bandwidth, but some more subtle differences are also relevant.

One of these subtle differences between mobile wireless and “wired”, or physically networked desktop computers, regards an underlying assumption whereby a conventional desktop computer is defined by what it “is,” while a wireless device is defined by what it “does.” In this way, desktop computers are categorized by platform and operating system (e.g. PC, Mac, UNIX), while wireless devices are categorized by function (phone, organizer, pager).

In addition to this underlying design assumption, other distinctions between wired and mobile wireless computing are emerging or increasing over time. Early wireless computing devices were transportable variants of desktop computers (laptop computers), modified to work with radio communication. But as the mobile market has matured, wireless devices have become smaller and more function-specific, shedding components and features as they shrink and become more specialized. Already the majority of mobile wireless computing devices have very limited data entry capability, with no keyboard. Screens of less than four centimeters are common, supporting only a few lines of monochrome text and little in the way of graphics. At the same time, desktop computers have become ever more powerful and feature-rich without changing physical form. Over time the two classes of devices have become very different from one another, and following this trend they should be expected to become as different from one another as a stereo is today from a microwave oven (similar underlying technology performing an entirely different function).

Bandwidth improvements in networking technology (e.g. multiplexing optical fiber and high-bandwidth copper) have delivered exponential capability increases for fixed installations, but what is available to the wireless user has remained relatively constant. Technically, wired connections have a huge bandwidth advantage over wireless, in that even one single pair of copper wires offers a whole frequency spectrum for data with little interference. The range available for a wireless transmission is, by comparison, negligible, as radio communication is restricted to very small licensed segments of the electromagnetic frequency spectrum, subject to many different environmental factors (e.g. terrain, humidity, solar flares) and a high degree of interference (e.g. other transmitters, unshielded electrical equipment). Data communications must also compete for frequency bandwidth against all other RF (radio frequency) applications, including voice (cellular phone).

Until recently, most Internet connections were made over dial-up analog circuits, and voice-quality wireless bandwidth compared favorably with what was available to fixed site or desktop computer users. But in the past few years networking technology has improved and become less expensive so that megabit (thousand Kbps) connectivity is increasingly available even for home computer users, and gigabit (million Kbps) is available to commercial or enterprise users. As technology improves further, wired bandwidth is growing exponentially (roughly following the pattern of Moore's law), while wireless has remained relatively constant (for the reasons described). With an exponential variable growing against a constant, the difference between wired and wireless bandwidth is increasing out of scale. Though Internet is generally considered to be one network with regard to protocol standards and connectivity from one point to another, it is at the same time becoming more evidently distinct networks, and increasingly disparate between wired and wireless users.

Along with differences in physical devices and network connections, so also are differences in application requirements between mobile and desktop computing systems. Many Internet tools and techniques are being developed with an implicit assumption of high-bandwidth wired connectivity, and such applications are proving to be infeasible or at least impractical for low-bandwidth mobile wireless users. Even the best tool for a high-bandwidth wired Internet user is quite often useless to someone connecting wirelessly using a phone or other small device.

As the Internet grows in scale it becomes increasingly difficult to take advantage of the information available without the aid of automation or agent technology. Agents are computer systems that automatically perform a user function in virtual space, in much the same way as a robot automates a mechanical function in physical space.

Two major classes automation agents are currently available: The most widespread technology is something called a “Web crawler,” or just a metadata (meaning data about data) web search too. Such systems run from a centralized server to automatically browse across the Internet and catalog each returned page of information into metadata matrixes, much the same way as a single user browses and notes page information. Agent tools of the sort are used by search engines including Alta Vista® from College Marketing Group Incorporated of Andover, Mass., WebCrawler® from Excite@Home Corporation of Redwood City, Calif., and Yahoo® of Santa Clara, Calif.

Along with metadata agents, another class of agent technology is emerging to handle the aspect of time with regard to Internet data. These agents are called “alert agents” or “change notification” tools, and they track only one set of data over time, providing a notification (“alert”) message to the user when some defined condition is met. Like Web crawlers, alert agents automate a user function, but instead of searching and cataloging millions or even billions of pages of information, an alert agent looks repeatedly at a single page and compares its content to some defined criteria. Because the content searched is quite limited, these alert agents tend to be less resource-intensive than their Web crawling counterparts: rather than supercomputers on an Internet backbone, alert agents can be run from a desktop computer using an ordinary network connection. Related examples can be seen in U.S. Pat. No. 5,388,255 (Wang Laboratories, Lowell, Mass.) that uses time stamps to identify page changes, or U.S. Pat. No. 5,898,836 (Netmind Services Inc., Campbell, Calif.) that does much the same with checksum polling. Both of these relate to tools for basic change notification function, both likewise rely on a constant network connection to operate (to poll content), and neither is oriented toward a wireless client operating through a proxy. Since these agent tools run from the user device, they only function when the device is connected, and they require local application code and processing power such as it often not available on a data-capable (“Web enabled”) cellular phone or other small wireless device.

Because of platform limitations wireless users are the ones in greatest need of automation, but wireless users are also the worst served by currently-available Internet tools, which tend to be designed for significant network resources and local (application code) processing ability. Tools designed for a networked desktop computer or PC do not necessarily work on a small wireless device, and this is the case for existing agent technologies on smaller devices such as cell phones. Mobile wireless devices tend to move in and out of network coverage, so anything that requires a constant connection (such as a polling notification agent) won't work well. Moreover, the basic polling function that these tools rely on can be very expensive to run over a wireless connection, where network costs are usage-based. Finally, most small devices such as Web-enabled cellular phones (e.g. WAP and iMode) have software flashed or burned in by the manufacturer, and do not have the ability to run local programs (i.e. Java or COM code) that these notification tools require for agent scripting. Though phone users might sometimes be able to receive a notification message, they lack the ability to create new notification scripts remotely (away from a connected PC): there is an unmet need for a wireless tool to provide this function.

Phone resources will certainly increase over time, but they should not be expected to reach a point where connectivity is unlimited, or ever to match the resources of a desktop computer. The paradigm of small mobile devices is truly different from the PC, and current notification agent technologies designed for the PC Internet user and are not suited to Web-enabled cellular phones or other wireless devices such as PDAs.

Existing agent technology is either tied to specific Web content on the server side, or its client side requirements are outside what is available on a cell phone or small wireless device. Mind-it® from Netmind services of Campbell, Calif. provides a good example of what is available today. This product provides a rich array of search features coded for a Web-connected PC, but it doesn't offer the same features to a phone. Mind-it requires a specific client browser (Explorer® from the Microsoft Corporation of Redmond, Wash.) that only runs on a very limited range of platforms, and that requires the client computer to have the ability to store and run local program code (further limiting this application to the PC) in order to allow a user to script a query which is necessary for creating an alert. Cell phones or similar wireless devices might receive a notification generated by an agent scripted elsewhere, such as on a PC, or in a very limited scenario they might go through a web page to trigger an existing agent script (again written on a PC), however, they get limited user functionality.

In contrast, the present Real-Time Data Agent (RTDA) can work on a phone or other very limited wireless device, and it provides full functionality to any client device with a browser, specifically to include (in fact designed for) small wireless devices that have limited or intermittent connections to the Internet. The fact that it does not require a PC to create an alert can be especially relevant in some situations where notification agents would be most useful, such as when a change (weather, mechanical failure) creates an unforeseen circumstance that might require immediate notification of the timely information (i.e. open routes, available hotel rooms).

The RTDA employs a proxy mechanism on a high-bandwidth Web server, along with a unique interface to allow users of the smallest devices (e.g., Web-enabled cellular phones) to remotely create and control dynamic data notification agents that run on the server. Others have used proxy connections for small devices: U.S. Pat. No. 5,727,159 (Kikinis, Saratoga, Calif.) discusses a way to save battery life for downloading files over a phone line and U.S. Pat. No. 5,809,415 (Unwired Planet, Redwood Shores, Calif.) employs a proxy to link (but not to integrate or to provide alert messaging) to connect a cellular phone to the Internet. It should be noted that the latter implementation reflects only a very limited physical connection into the Internet, and not a link into the (HTML) pages of the World Wide Web. It is clear from the literature that the concept of a proxy is commonly used for connection services, however, the RTDA adds another level of value to the proxy. The RTDA uses the proxy to provide the function of client application processing by migrating the client's role to a networked server. This provides an alert creation interface optimized for a very small device. This concept is both new and peculiar to RTDA.

In addition to the foregoing prior art, the following patents appear to disclose possibly relevant concepts of lesser importance: List all patents except 4 that are listed in prior art.

The operation of RTDA between the data telephone (or other small wireless device) and the proxy-based agent application server is analogous to the operation of a remote control respective to a television set. Like the TV, the RTDA server receives the high-bandwidth broadcast content, but like the remote control on that television, the phone or other small device actually controls what the server is doing and what content it receives.

This invention comprises a very special thin client notification tool that can build and initiate a query from a Web-enabled cellular phone (without a PC), and that can cover the World Wide Web without limiting what information might be queried.

### SUMMARY OF THE INVENTION

Briefly described, the invention comprises a unique computer interface and system architecture whereby alert notification agents can be created and managed from a wireless telephone or other wireless device that has limited connectivity and platform resources. The invention, referred to as a Real-Time Data Agent (RTDA), runs on a server to provide small mobile wireless network clients (e.g., Web-enabled cellular phones or PDAs with browsers) with an ability to create, initiate, and remotely control server agents to give immediate notification for relevant changes (per defined criteria) for any World Wide Web data that can be viewed through the browser on the given device. RTDA is a tool to provide manageable real-time notification capability to the users of wireless network devices who would otherwise not have this ability while mobile.

The tool consists of a Web proxy and application server that renders a client interface (displayed in a browser) to provide a function for any user to create and receive notification of relevant information from part of any World Wide Web page or data that can be viewed from the wireless device. The invention focuses on data telephones and small-form browsers (with limited functionality), especially those using specialized wireless protocols such as cHTML (iMODE) or WAP. The invention runs primarily from an application server within the Internet (or central network), but one of its key features or components is found in the screen interface for the client device (e.g., data-capable cellular phone). This interface is based on an actionable list paradigm with defined element types, to allow a user to instantly convert any page into a vertical list, from which any element may be selected for change or event notification per a defined set of boolean-based criteria. It is called “real-time” because the agent server returns a link to the original page address when the criteria are met, thereby delivering the most current version of the data (in real time).

The function of RTDA is based on a proxy where views are server-driven, running the client-side application on the server and delivering screens to the wireless device as pages through a proxy. The defining concept of RTDA (primary design assumption) is that content on the client device is limited to finite types, primarily alphanumeric text that can be parsed (or broken down) into numbers and strings. Anything else including graphics, formatting, and hidden code is assumed to be irrelevant to the content, except as defining the structure or context around which the content is shaped. This is true whether RTDA is deployed with its own Web proxy server or it is built to interact with an existent server such as that included with WAP (Wireless Application Protocol).

RTDA's operation is straightforward. When invoked, it provides a function to break or parse a viewable page into a vertical list of typed elements, but removing extraneous information (formatting, graphics references), and delivering the result as a scrollable list from which the user can click to select any element for alert notification. From the users perspective, the whole process appears as a function of the phone, while from a system perspective it represents a fairly complex logical process being done through a server or servers, interweaving a proxy addressing server with a with a robotic agent server (one transparently emulating repetitive activities of many individual client devices) and a messaging system for notifications. The real work is happening on the server side of the network, while the presentation and function is fully implemented on the wireless client device, where no application code actually resides. RTDA can be linked to applications on a client device, but its functionality does not require any local code. Some parts of the system can also be adapted from existing components, such as in a WAP server installation the notification function can be implemented to work around the existing WAP (proxy) server rather than having a proxy internal to RTDA.

The RTDA function is achieved through a system and method described in further detail herein. Each of its individual components (client device, proxy server, agent application server, etc.) can be implemented in a number of ways. It works through a client browser, but can be presented to almost any wireless client device. It requires a proxy server, but which proxy server is only a factor for design consideration, not otherwise significant. It requires an outbound messaging or notification mechanism, but this can either be an internal function of the server application, or it can be done through most existing mail servers.

The invention may be more fully understood by reference to the following drawings.

### BRIEF DESCRIPTION OF THE DRAWINGS

FIG. 1 is a block diagram providing a functional model of the preferred embodiment of the invention. It shows single instances of each component, including those such as (World Wide Web) content servers and Web-enabled cellular phones that lie outside of the proprietary portion of the system, and whose number is undefined.

FIG. 2 is a progressive graphical view of a phone browser interface before and after the RTDA function has been applied.

FIG. 3 is a flow diagram describing the steps of the basic process of RTDA in its most rudimentary implementation and any deployed system should be expected to include additional features and operational elements, such as configuration options and links to other World Wide Web servers and processes.

FIG. 4 is a protocol-based block diagram of the system showing some of the basic information formats being used by the system.

FIG. 5 shows another embodiment of the invention in which the RTDA server has been set up as a transparent wrapper to an existing proxy, in this case a WAP server, as a representation of how the basic technology might be applied to a variety of implementation environments.

### DETAILED DESCRIPTION OF THE PREFERRED EMBODIMENT

During the course of this description like numbers will be used to identify like elements according to the different views which illustrate the invention.

The description given is for a basic implementation of RTDA technology through a simple Web proxy. The same function can be implemented in several variants, including the use of almost any existing proxy (WAP server included), or through code on the client device. The following description is presented to enable one of ordinary skill in the art to understand and make and use the invention as provided in the context of a particular application and its requirements. Various modifications to the preferred embodiment will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed.

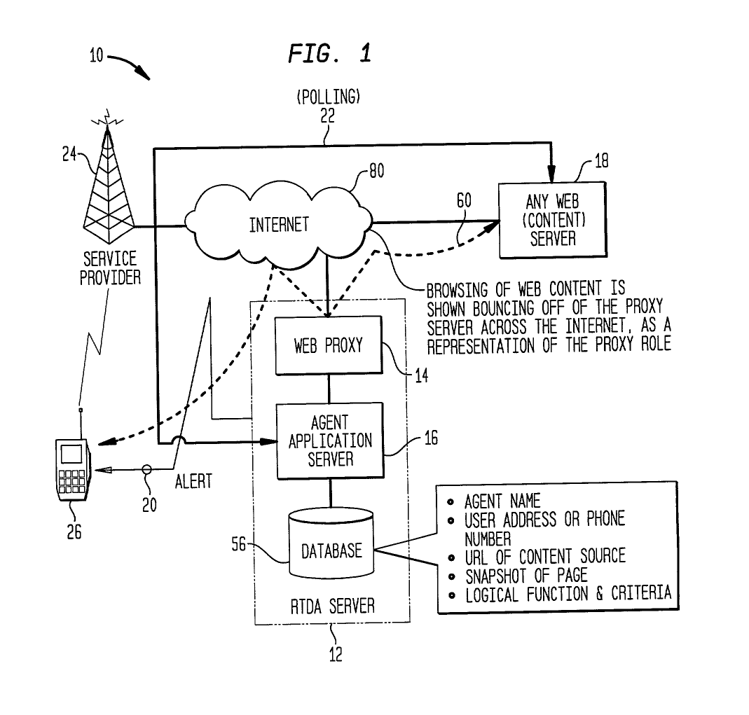

The basic configuration of the preferred embodiment 10 shown in FIG. 1 includes the following components: an RTDA server 12, which refers to the whole server implementation that is used to provide RTDA functionality, including both the Agent Application Server and the Web Proxy; a Web proxy 14, that is a specific type of Web server that acts as an intermediary in navigation: proxies are described elsewhere in related art, but this specific implementation is a single proxy that serves to collect addresses and information before forwarding page content to the client device; an agent application server 16, which is just a function or part of the RTDA server that polls or collects content, and that sends agent notifications to the phones (or other small wireless devices); a Web content server 18 which might be any Web server on the Internet that provides at least somewhat dynamic content (static text never changes, and therefore it doesn't cause notifications); an alert message 20, which is the notification sent out to the client device to say that the given information criteria have been met: in the preferred embodiment, this comprises a message whose subject line is the notification (notification script) name, and whose content is a link to the URL address of the original content source; the polling function 22, which refers to the process of checking a site or content source to see if it has changed (in an alternative embodiment, a direct information feed from the content provider can be used to supplement or replace the polling process); a wireless service provider 24, which is the cell phone service provider that, in the context of RTDA, acts both in the role of providing the physical network, and also as the ISP (in another Intranet embodiment the service provider can refer to the local network, or any combination of ISP and physical network); and the client device 26, that is assumed to be a Web-enabled cell phone, such as a WAP or iMODE (NTT in Japan) phone. This is a cell phone that operates on a digital (packet) network and that includes an Internet browser application (generally one that is proprietary and somewhat limited). In many cases, the client might be a PDA (e.g., Palm or CE device) or the system might even be accessed through a normal PC browser, though that is optimized for wireless or thin connections.

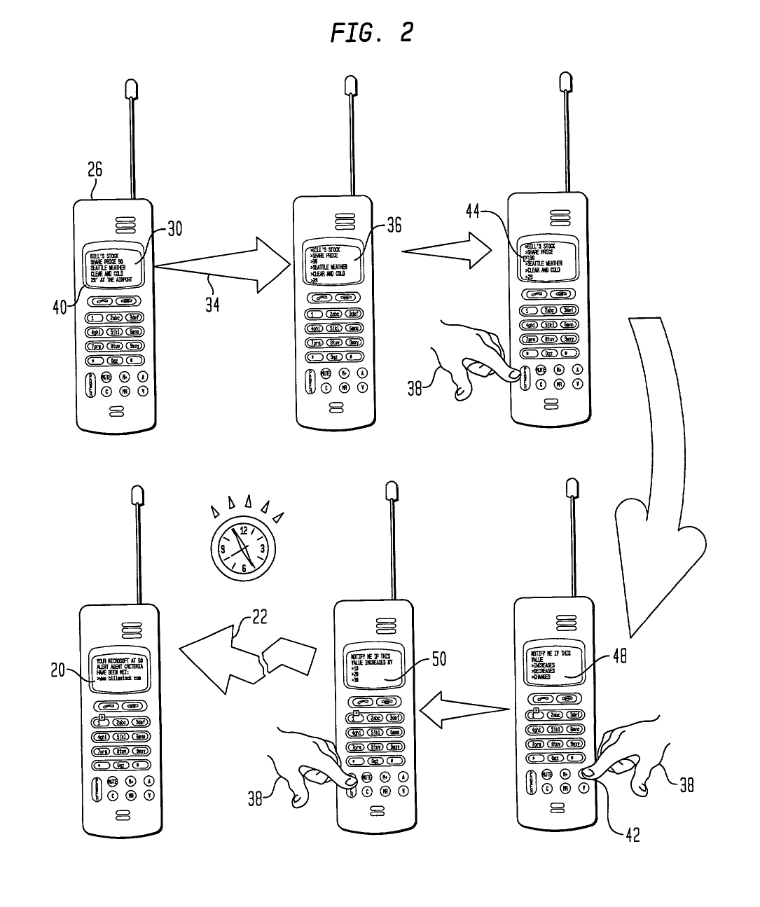

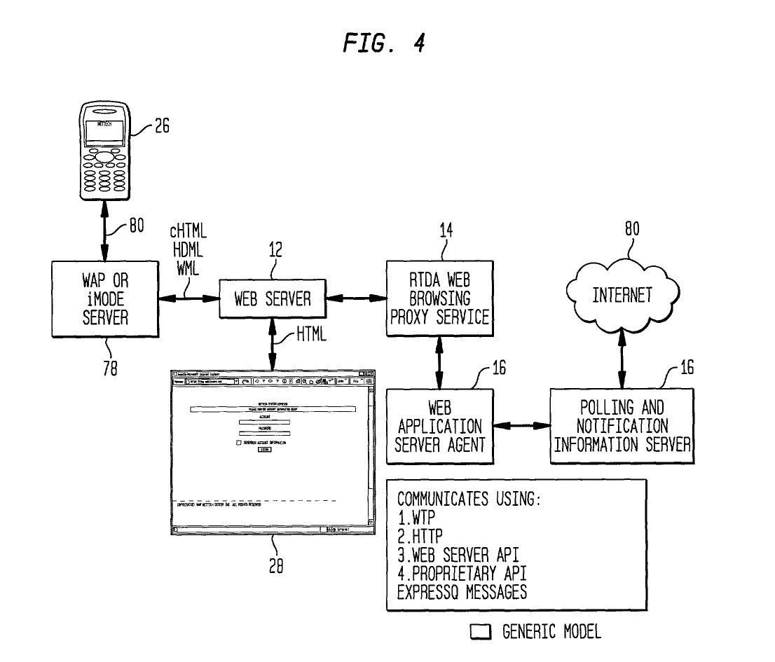

Other components and subsystems of RTDA include a menu interface 28, as shown in FIG. 4, the home page of the Web proxy server (14) that provides links and helpful navigation tools, all of which have RTDA embedded in their proxy; the content page 30, as shown in FIG. 2, that is the original content for which some notification is being set. Using the stock price example, it would be all of the formatted information delivered on the page showing stock prices.

Separate from the Web information itself is also the content page URL 32, that is the address of the page that shows the original content for which some notification is being set. Because RTDA operates through a proxy, the actual URL can be somewhat confusing: in the stock price example, it would be the Internet address of the server and page that gives stock price information.

The embedded alert function 34, shown in FIG. 2, is a post-proxy addition to a content page. It is the same information and presentation passed through the proxy, only with an option added to apply this RTDA alert notification function to any page browsed (through the proxy). The first stage of this alert function is an actionable list interface 36, that is itself an alternative presentation of any given Web page (parsed to separate numbers from text and returned in list format) that can be invoked on demand from the proxy server. On the other side of the interface is a user 38, accessing data through the client device browser 40 (process called browsing 60, shown in FIG. 1), which is assumed (but not required) to have functional limitations associated with a small form factor (screen space, local processing). Associated with this client browser 40 should also be an ability to receive a message, either as e-mail within the browser application itself or from some related function on the client device 26 platform. Within this client browser 40, the primary navigation mechanism is assumed (but not limited) to be a scroll function 42, and it reflects the minimum functionality found in small devices. Few small devices have a mouse. Instead they use a system of buttons, a puck, touch screen, or a little control wheel. Among this variety of navigational tools the minimum is a vertical scroll (all have this function): RTDA is designed to work with this minimum capability expectation, and for this reason is build on a vertical scroll interface.

Another key part of the client interface is the list element 44. When the alert function 34 is applied to the content page 30, information is broken up into a vertical actionable list 36, primarily divided between numbers and strings. Each item line or element on the vertical list (string or number) is made actionable, so the user can navigate (scroll 42) to that element and select (a default function of the client device, usually by pressing a key) to receive a function or another menu. Following this initial actionable list is a list of text functions, 46, or in the event that the selected element is a number, then a similar list of numeric functions 48. The list of text functions 46 and the list of numeric functions 48 take up the same place in the menu interface. If the list element 44 selected is a word or body of text (not a number), then the list of functions will be text based 46. The real driving criteria is in the type of information given on the original content page 30 but the agent function criteria 50 should be equivalent but different between text and numeric functions (reflected in lists 46 and 48). If the selected element 44 is numeric, then the list given will be the numeric one 48, based on Boolean logic, to give notification to the user if the value increases, decreases, or changes by a certain amount. If the selected element 44 is text, then the list 46 would be based on functions such as “includes,” “does not include,” “changes,” and similar criteria reflecting the text equivalents of Boolean, recursion, or set theory logic.

The final stage of the agent process is when the alert notification message 20 that is transmitted over the wireless network 52 to the client 26. This occurs via e-mail, SMS (Short Messaging Service), or whatever communication mechanism is available to reach the user when agent criteria are met. It includes the agent name 54 as its subject, and a link to the content page address (URL) 32 in its body. The agent name 54 serves as the identifier for the agent polling 22 query, the key field for the server agent data store 56. This server agent data store 56 is a repository where all agent information is stowed on the server (RTDA Server 12, or an ancillary database server associated with it). IN the preferred embodiment this store should be a standard (SQL or object) database, but the same function cold be performed with any sort of data repository including file data an draw memory (coded data structures). In addition to the agent name 54 or subject line, a user address 58 is also saved into this data store. This address is one of the key data elements for any server agents: it is the return address for the client request, or in the case of the client being a cell phone it is the phone number of the client making the agent request, and, therefore, the ultimate destination to send any alert notification.

The primary working mechanism by which the server performs its agent functions is through content polling 22, which is initiated with a user browser function 60 through the proxy. The polling cycle 62 is the frequency and duration that content polling 22 occurs. It is a setting included in the initiation process. All of these parts and pieces touch on the key element of the whole system, the alert agent 64. This alert agent is the biggest single piece of system functionality but it is almost an intangible, as a convergence point between all the parts and pieces of the system. Everything comprising one instance of an alert or notification process is an alert agent 64. More than a single component, the agent alert 64 is a general term to refer to all of the parts and pieces that come together to make up one whole instance of a notification on the server. It would include all screen interfaces (28, 30, 34, 36, 42, 44, 46, 48, 50 . . . ), server functions (14, 20, 56, etc.).

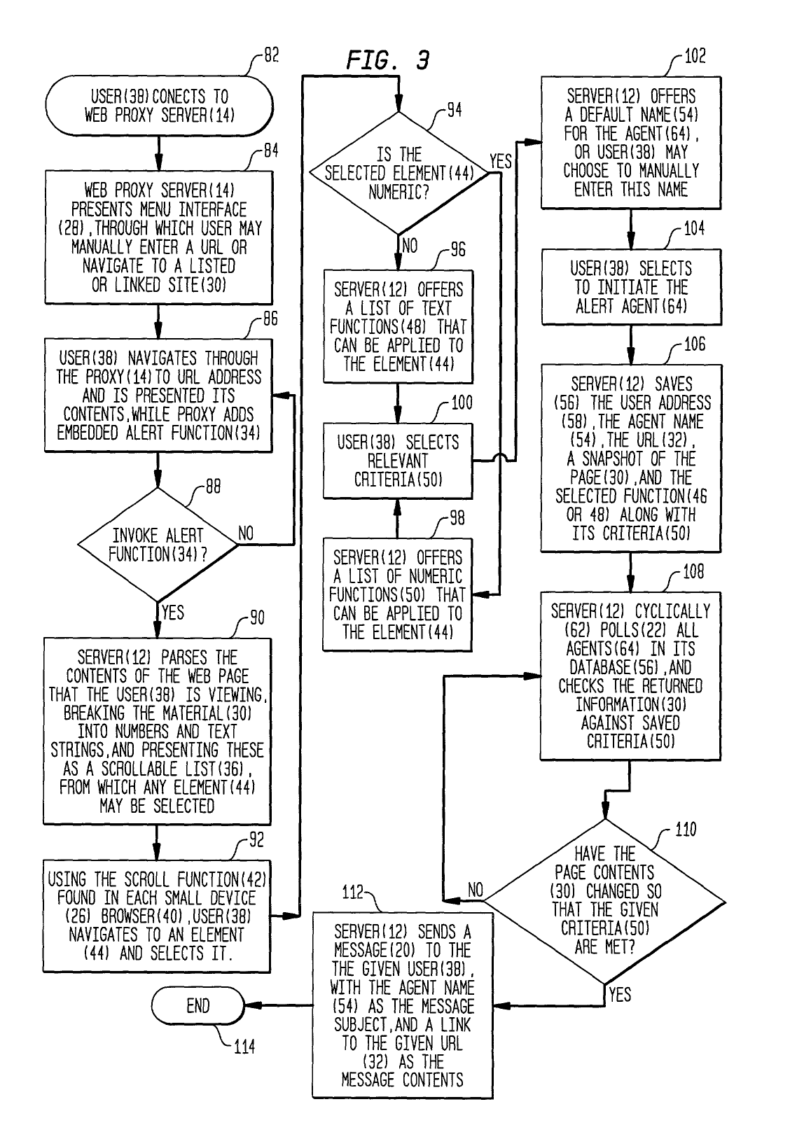

In the logical process of RTDA FIG. 3, the initial step 82 occurs when the user 38 connects to the Web Proxy Server 14 over the Internet 80. This is followed directly by step 84 whereby the Web Proxy Server 14 presents a menu interface 28, through which a user may manually enter a URL or navigate to a listed or linked site 30. The presentation of interface 28 is followed immediately by a decision process 86 whereby user 38 navigates through the proxy 14 to a URL address and is presented its contents, while the proxy server adds embedded alert function 34, whereupon, a logical decision 88 must occur as to whether to invoke alert function 34.

If the outcome of this logical decision is negative (user chooses not to invoke the function), then the process reverts to the previous step 86, while if the decision is “yes” then the process progresses into another step 90, whereby the server 12 parses the contents of the Web page that the user 38 is viewing, breaking the material 30 into numbers and text strings, and presenting these in the format of a scrollable (actionable) list 36 from which any element 44 may be selected. This list is followed by a step 92, where using the scroll function 42 (found in even the most minimal browser 40), a user 38 navigates to an element 44 and selects it. At this point a second underlying logical decision 94 occurs regarding whether the selected element 44 is numeric: the server, not the user, makes this choice, and the resulting information presentation is dependent on its outcome. Given an element 44 of non-numeric text (negative underlying decision), the next logical step 96 is for the server 12 to offer a list of text functions 48 that can be applied to the element 44. Given the alternative case where the element selected is numeric, 94, the next logical step 98 is for the server 12 to offer a list of numeric (e.g. Boolean) functions 50 that can be applied to the given element 44. Both of these cases are followed by a step 100 where the user 38 selects relevant criteria 50 from the list given. Once criteria are selected, another logical step 102 occurs where the server 12 offers a default name 54 for the newly-created agent 64 (the outcome of this whole process), or a user 38 may choose to manually enter the agent name.

After the name has been accepted or entered, then follows a step 104 where the user 38 selects to initiate the alert agent 64, and step 106 where server 12 saves 56 the user address 58, the agent name 54, the URL 32, a snapshot of that page 30, and the selected function 46 or 48, along with its criteria 50. Given a saved data set, the next step 108 is for the server 12 to cyclically poll 22 all agents in its database 56, and check the returned information 30 against saved criteria 50. For each returned page, a logical comparison 110 is performed whereby the page contents 30 are evaluated as to whether the given criteria 50 are met. In the event that the criteria are not met, the process reverts to the previous step 108, but if the contents 30 have changed to meet the criteria, another step 112 occurs whereby the server 12 sends a message 20 to the given user 38, with the agent name 54 as the message subject and a link to the given URL 32 as the message contents. After the alert message has been sent (or a timer has run out), the whole process ends 114.

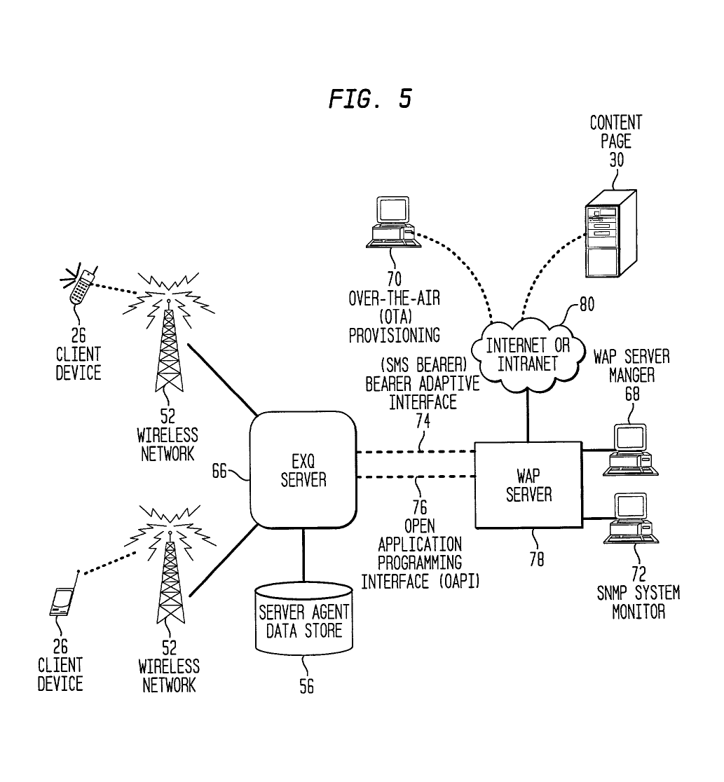

To understand the embodiment of RTDA in isolation, it is also important to look at it in the context of another proxy mechanism and network, namely as a hosted extension of a WAP server. Such a configuration is shown in FIG. 5 where RTDA is wrapped around a WAP server 78 from Nokia Group of Espoo, Finland. In this model, ExpressQ™ Server 66 is an existing Broadbeam product into which RTDA's functions can be added. WAP Server Manager 68, Over-the-Air (OTA) Provisioning 70, SNMP System Monitor 72, Bearer Adaptive Interface 74, and the Open Application Programming Interface (OAPI) 76 all reflect parts of Nokia's WAP server product which can be found elsewhere documented either on their Web sit, or in their product's technical literature. None of these parts are components of RTDA, though their functionality can be applied to its use, according to the methodology described in this disclosure. Another view is of (standalone) RTDA in terms of marketed components reflect in FIG. 2.

This Real-Time Data Agent (RTDA) includes architecture and set of programs that run on a server (one or more computers), and provide small mobile wireless network client devices with the ability to create and remotely control server-based agents to give immediate notification of relevant changes to information on any World Wide Web (or Intranet) site that can be viewed on the given device. RTDA is a tool to provide information notification in the most expedient way to the lowest level of wireless device. It provides the ability to receive a notification message, and to create a new alert query of any available information from the client (wireless) device. It focuses on small wireless devices that include a browser, especially Web-enabled cellular phones such as those running iMODE (cHTML standard from Japan) or WAP. Though the RTDA runs primarily from an application or Web server within the Internet (or central network), its core technology is an actionable interface linked through a browsing proxy server that allows a user to instantly convert any page as an actionable vertical list, from which any element can be selected for notification per a dynamically-defined set of criteria.

The technology of RTDA works from a network or web server, but the concept of its design originates on the client side. Very small wireless clients such as cell phones have limited ability to read and understand web page information, and most can only process alphanumeric text (numbers and strings of characters). RTDA extrapolates on this idea conceptually to assume that all relevant content information on a page is alphanumeric text, and all graphical information is considered to be background or page format. This is a pragmatic reflection of the technology and form factor of small wireless devices, as even the devices that can view graphics (many or most cannot) have such small screens that graphics are not generally useful as information. This is especially true of web-enabled cellular phones, but it is similarly true of other small wireless computing devices. Making a logical extrapolation from this empirical condition leads to the assumption of alphanumeric text as a reflection of a small device's view of the world.

The second basic principle of RTDA also comes from Web browser phones, where the phone must use a server-side proxy to access the World Wide Web. Not every small device inherently uses a proxy, however, any device that can access the World Wide Web can access it through a proxy. The value of the RTDA proxy is two-fold: web access and to provide a virtual client server configuration, using application space on the server. Small wireless devices, especially phones have a well recognized technical weakness in their inability to run local application code. Running the entire application from the server side through the RTDA proxy overcomes this technical weakness.

Though key functionality is oriented toward the client, the majority of processing occurs on the server side of the application: no application code actually need reside on the remote wireless device. A proxy server is needed to provide the browsing function to the client, essentially taking the role of the client application. The RTDA application server can either be incorporated into the proxy or, with an environment such as WAP that includes its own proxy, RTDA is attached to and work through the WAP proxy. With a Web proxy (its own), RTDA can be self-contained into one server, or distributed into several, at least one of which would be a Web/HTML server.

Following through the RTDA process model, the system, when invoked, provides a function to break a viewable page into a vertical list of typed elements, much like “view source” on a conventional browser, but through the server by parsing a saved copy of the client's screen information, either taken internally from the proxy or captured from the output data stream of some existent Web proxy server (such as Broadbeam's Web agent server or phone.com's WAP server). Screen data is captured from the information being sent from the remote Web server, then information content is type-categorized as either numbers or strings, and a snapshot is taken of non-alphanumeric content (formatting and any graphics) to be used for structure reference. Both the data content and background reference are then stored in the server before being transmitted out to the user, along with a tagged link to a server program through which the notification agent scripting function can be invoked. If the user selects this tagged link, the server then retransmits out the contents of the current page, but this time parsed and reformatted into a type categorized actionable list that the user can scroll through using navigation on the client browser. The use of scroll as a navigation mechanism is a reflection of the technology. Few small devices have a mouse or keyboard for input, but even the most basic phone device offers scroll navigation. Using this scroll function, a user can go through the given list and select one element. This selection is received at the application server (16) which then replies with the relevant choices or options (depending on whether the selected element is numeric or a character string, i.e. word or words), followed by criteria (again dependent on data type).

An example WAP screen for the “Bill's Stock” site might have the following information:

Bill's Stock

Share Price $90

Seattle Weather Clear and Cold

29 at the airport

When the RTDA agent function is applied to this screen, the client's data page becomes:

($001) Bill's Stock

($002) Share Price

(#001) 90

($003) Seattle Weather Clear and Cold

(#002) 29

($004) at the airport

where the parts in parenthesis represent the system information on each element (not shown on the client screen), with “$” to denote a string and “#” to denote a number. Formatted as an actionable list on the phone screen, this might appear something like the following, where “>” denotes a selectable menu item:

>Bill's Stock

>Share Price

>90

>Seattle Weather Clear and Cold

>29

>at the airport

The user then scrolls through the vertical list and selects an element, for example, Bill's stock share price (#001 on the system list above), and is then presented with a assortment of criteria from which to choose (e.g., <,>,=, includes, does not include, or other criteria). This given list depends on whether the original element was a number or a string. Once the criteria selection is complete, the user receives a final initiation screen from which a name, duration, frequency, and/or other parameters can be defined. Default values are offered for all elements on this last screen, along with an “initiate” function, shown as either a screen link or hot key, depending on the device application. When this “initiate” function is selected, the agent query is saved to the server, where begins to run according to its scheduled cycle. The server periodically calls up the Web site from which the data was originally taken to compare it to the defined criteria (this process is called “polling”).

Once a query is initiated, it is saved into the application database and then run, along with any other agents, in scheduled batches by the application agent handler. On each batch cycle the RTDA server checks each user-selected Web page by emulating a client device's request from the server: the RTDA server pretends to be the client making the request. It is important to note that all client requests come to the server through the proxy, whether the initial user setting or the subsequent polling done by the RTDA server. In so doing, the target content server will not distinguish requests that originate with the wireless client, from similar requests that originate on the proxy server. Though the function of the wireless client is being repeatedly performed, no wireless traffic is generated at all during this polling process—rather all is emulated or virtual between servers across wired Web connections.

When the agent criteria are met (i.e., in the given example, when Bill's share price falls to 60), a message is sent to the client. The subject of this message is the name of the agent (either a default by the system, or one assigned by the user), and the message content link to the original page where the source information is shown. The user can then click on this link and be taken to the page showing the most current information, which has met the defined criteria. There is no problem with the returned page being read from a limited function client since the client had to have been able to navigate to the page in order to create a notification agent.

The client interface and agent creation (scripting) mechanism is simple enough to be intuitive for the average user, and not to require any training. At the same time, the system provides powerful functionality that is useful for a great many applications: RTDA makes an infinite array of time critical data available to wireless users in a format that any given device (and user) can understand. Other products and sites may provide predefined notification messages such as real-time stock quotes, or some other selected (and inherently constrained) pieces of information, but no one has yet mastered universal dynamic notification for wireless. This new invention (RTDA) makes the most up-to-date information instantly available anytime, anywhere, to anyone with even the most rudimentary wireless Web client (e.g. WAP or iMODE phone).

More than just expedient wireless information, RTDA is built on technologies that provide broad functionality to anyone, regardless of whether they might be using a wireless link. The tool is designed to overcome the limitations of a wireless network, but its application is pervasive. Everyone has a need to be notified, but no one type of content is universal. Pilots and drivers are concerned when the ground temperature drops below freezing; travelers want to know the instant a flight is canceled (FAA site, flight #, status=Canceled); merchants might want to know when a shipment is delivered (FedEx or UPS status). The possibilities are as limitless as they are varied. RTDA addresses these possibilities by not limiting their sources, and effectively making anything available for notification to anyone who has a wireless or wireline computing device.

The utility or value proposition of RTDA might be compared to search engines such as Alta Vista® (College Marketing Group Incorporated, Andover, Mass.) in that the RTDA agent tool provides the power of a virtual user (robot) performing a defined function with greater resources than are available to the individual. For Alta Vista® this proposition equates to a direct connection to the Internet backbone and massive supercomputing servers for the greatest amount of data, often at the expense of timeliness (links being out of date). RTDA approaches the information issue differently, going instead for the timeliness aspect of a single piece of data, rather than all that might be found, to deliver an equivalently relevant amount of user utility with only modest resources.

From a user's perspective, the Real-Time Data Agent is a handy tool. It converts any Web phone or wireless connected device (e.g., web-connected pocket organizers) from a novel toy into a powerful data tool, with real-time knowledge of critical information. Mobile Web browsing is an interesting and often entertaining feature, but mobile users can't check Web sites for information constantly. The so-called wireless web is conspicuous in technology, but its current utility is little more than a novelty, as it does not return much basic value. RTDA changes this value proposition by freeing the user from having to repeatedly check critical information, without the penalties of manually performing such a process. Because this function runs on the server and no bandwidth or resources are required on the client side until the criteria are met, there is a huge savings not only in effort but in wireless communication costs. At the most basic level, this provides more than a novelty, but tangible basic utilities of time, money, and information.

Besides basic utilities, RTDA also delivers on the utopian goal of dynamic application creation without any code development. Though the agent technology is an application with respect to the server, each agent a user builds from the wireless device is in effect an application with regard to the function it performs: one application (agent) can check when a delivery is ready; another can find out if a problem is resolved; another might watch the help desk log for specific trouble reports. All of these can run in the background at the same time; all can be done from the same interface on the wireless device; and none require that program code be written. Applications (RTDA agents) can be born and die exactly as needed, anyplace and anytime, to capture real opportunities in real time.

The foregoing description of the embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description.

We claim:

1. A method for obtaining updated data on a portable unit from a server connected to a global communications network, said method comprising the steps of:
a. transmitting a request for data from said portable unit to said server;
b. parsing the contents of said data request into strings of elements;
c. transmitting at least one of said strings to said portable unit;
d. selecting an element from said one of said strings;
e. selecting a relevant criteria that can be applied to said element;
f. transmitting said selection from step e. from said portable unit back to said server; and,
g. transmitting updated data from said server to said portable unit based upon said selected criteria.

2. The method of claim 1 wherein said transmitting steps comprise wireless transmitting steps.

3. The method of claim 2 wherein said paring step b. further comprises the step of:
h. parsing said contents of said requested data into numeric and text strings.

4. The method of claim 3 wherein said parsing step b. further comprises the step of:
i. presenting said strings as a vertical list of scrollable elements to said portable unit so that the user of said portable unit can select an element of said list from which to receive future updated data.

5. The method of claim 4 wherein said global communications network comprises the World Wide Web (WWW).

6. The method of claim 5 wherein said portable unit is a wireless portable unit.

7. The method of claim 6 wherein said wireless portable unit comprises a cellular telephone.

8. The method of claim 6 wherein said wireless portable unit comprises a Personal Digital Assistant (PDA).

9. A server apparatus for providing updated data from a global communications network based upon requests from a portable unit, said server apparatus comprising:
parsing means for parsing the contents of data requested by said portable unit into a list of elements; and,
updating means for applying criteria selected by said portable unit to at least one of said elements and for updating data requested by said portable unit based upon said criteria,
wherein said updated data is supplied by said server apparatus back to said portable unit based upon the element and criteria selected.

10. The server apparatus of claim 9 further comprising:
wireless means for communicating said data between said server apparatus and said portable unit.

11. The server apparatus of claim 10 wherein said global communications network comprises the World Wide Web (WWW).

12. The server apparatus of claim 9 wherein said portable unit comprises a cellular telephone.

13. The server apparatus of claim 9 wherein said portable unit comprises a Portable Digital Assistant (PDA).
